(19) United States
(12) Patent Application Publication
(10) Pub. No.: US 2026/0106428 A1
(43) Pub. Date: Apr. 16, 2026

(54) OPTICALLY PUMPED SOLID-STATE LASER

(71) Applicant: ams-OSRAM International GmbH, Regensburg (DE)

(72) Inventors: Johann RAMCHEN, Hausen (DE); Joerg Erich SORG, Regensburg (DE); Norwin VON MALM, Thumhausen/Nittendorf (DE)

(73) Assignee: ams-OSRAM International GmbH, Regensburg (DE)

(21) Appl. No.: 19/115,974

(22) PCT Filed: Sep. 13, 2023
(86) PCT No.: PCT/EP2023/075177

§ 371 Date: Mar. 27, 2025

(30) Foreign Application Priority Data
Sep. 30, 2022 (DE) 10 2022 125 326.0

(51) Int. Cl. H01S 3/08; H01S 3/081; H01S 3/0941; H01S 3/16

(52) U.S. Cl. CPC H01S 3/08095; H01S 3/08059; H01S 3/0813; H01S 3/09415; H01S 3/1603

(57) ABSTRACT

The invention relates to an optically pumped solid-state laser, wherein a pump radiation source and a laser resonator for forming at least one standing wave with an active laser medium are arranged relative to one another in such a way that the laser resonator can be pumped by the pump radiation source, wherein the laser resonator is delimited at a first end by an end mirror for reflecting the standing wave, and at a second end by an outcoupling mirror for reflecting the standing wave and outcoupling laser radiation, and wherein the laser resonator has at least four reflectors at which the direction of extent of the standing wave changes.

### CROSS-REFERENCE TO RELATED APPLICATIONS

The present application is a national stage entry from International Application No. PCT/EP2023/075177, filed on Sep. 13, 2023, published as International Publication No. WO 2024/068282 A1 on Apr. 4, 2024, and claims priority to German Patent Application No. 10 2022 125 326.0, filed Sep. 30, 2022, the disclosures of all of which are hereby incorporated by reference in their entireties.

### FIELD

The invention relates to an optically pumped solid-state laser, in particular a surface emitting optically pumped solid-state laser.

### BACKGROUND

Lasers, solid-state lasers and semiconductor lasers are known. Semiconductor lasers comprising various material systems are known, in particular, although with these hitherto only certain wavelengths have been able to be realized in a simple manner. Further wavelengths can be provided by solid-state lasers, in particular by solid-state lasers pumped by means of laser diodes (diode-pumped solid-state (DPSS) lasers).

It is an object of the invention to provide an optically pumped solid-state laser which is compact and has a simple construction.

This object is achieved by the optically pumped solid-state laser with the features of claim 1. Claims dependent thereon specify preferred embodiment variants.

### SUMMARY

In accordance with one embodiment, the optically pumped solid-state laser comprises a pump radiation source and a laser resonator for forming at least one standing wave with an active laser medium. The pump radiation source and the laser resonator are arranged relative to one another in such a way that the laser resonator can be pumped by the pump radiation source. The laser resonator is delimited at a first end by an end mirror for reflecting the standing wave, and at a second end by an outcoupling mirror for reflecting the standing wave and outcoupling laser radiation.

The laser resonator additionally has at least four reflectors at which the direction of extent of the standing wave changes.

The laser resonator can be of particularly compact design as a result.

In accordance with one embodiment, the laser medium extends in layer-like fashion. In particular, it can extend in layer-like fashion along a principal direction and/or a principal plane. Accordingly, the laser medium has e.g. a planar top side and—preferably parallel thereto—a planar bottom side, wherein possible side faces are significantly smaller than both the top side and the bottom side, e.g. by at least a factor of 5 or 10 20 or 50.

In this case and generally, the reflectors can be arranged in such a way that the standing wave extends in zigzag fashion and in so doing extends multiple times through the laser medium.

In particular, the standing wave can extend through the laser medium along its direction of propagation and can then be reflected at two successive reflectors at a top side of the laser medium and can then once again extend through the laser medium and can then be reflected at two successive reflectors at the bottom side of the laser medium and can then once again extend through the laser medium.

Here and hereinafter, the terms “top side” and “bottom side” describe two at least substantially opposite planar sides of the layer-like laser medium. Which of the two sides is assigned the term “top” or respectively “bottom” is arbitrary. The terms “top” and “bottom” serve merely to define orientations of the same type in relation to the below-described optional further components of the solid-state laser.

Along the standing wave, the resulting sequence is thus as follows: laser medium—reflector—reflector—laser medium—reflector—reflector—laser medium. This sequence can be repeated as long as desired until then finally the laser radiation is outcoupled by the outcoupling mirror or is reflected by the end mirror. In other words, e.g. end mirror—laser medium—reflector—reflector—laser medium—reflector—reflector—laser medium—reflector—reflector—laser medium—reflector —reflector—outcoupling mirror.

The standing wave preferably extends perpendicularly or at least substantially perpendicularly through the in particular layer-like laser medium. For example, it can extend through the in particular layer-like laser medium at an angle of 85 to 95 degrees inclusive.

For example, in the case of each of the sequences described above, it can extend perpendicularly or at least substantially perpendicularly through the laser medium.

Two successive reflectors can be formed by different sections of an elevation, in particular prism, on the laser medium. That applies in particular, but not exclusively, to the respective two successive reflectors in the case of the sequences described above. The elevation can be shaped in such a way that it collimates the standing wave. The elevation can be provided with a specularly reflective layer (also called specularly reflective coating). The elevation can consist of a guide medium. A plurality of such elevations composed of the guide medium can be present on a side (top or bottom side) of the laser medium. These elevations can be connected to one another by the guide medium, or they are not connected to one another by the guide medium.

In accordance with one embodiment, the outcoupling mirror and/or the end mirror comprise(s) or consist(s) of one or more layers on the preferably layer-like laser medium. The layers can be formed directly on the laser medium, e.g. on the top or bottom side thereof, or as an alternative thereto at least one further layer can extend between laser medium and outcoupling mirror and/or the end mirror.

In accordance with one embodiment, the solid-state laser additionally comprises a preferably layer-like guide medium arranged on one side of the laser medium and serving for guiding the standing wave, wherein at least two of the reflectors are formed as an elevation of the guide medium. The elevation can be provided with a specularly reflective layer.

In this case, it is advantageous if the specularly reflective layer is arranged on the guide medium rather than on the laser medium. Between the excited levels in the laser medium and the conduction band of the layer, charge carrier exchange might otherwise occur, which in turn leads to nonradiative recombination and loss of efficiency, in particular as a result of plasmon excitation. This is particularly advantageous if the specularly reflective layer is a layer which comprises a metal or consists of metal or metals.

Preferably, the solid-state laser comprises two guide media of this type, one on the top side and the other on the bottom side of the laser medium.

In accordance with one embodiment, the solid-state laser has an upper (preferably layer-like) guide medium arranged on the top side of the laser medium and serving for guiding the standing wave with a plurality of elevations, each forming two of the reflectors, and also a lower (preferably layer-like) guide medium arranged on the bottom side of the laser medium and serving for guiding the standing wave with a plurality of elevations, each forming two of the reflectors.

The guide medium with reflectors enables simple production of the solid-state laser. The upper and lower guide media can be connected to the laser medium by means of a refractive index-matched material, for example by lamination or adhesive bonding. In this case, it is possible to provide the guide medium for a plurality of lasers in the form of a wafer and the guide media can be applied already-before singulation-on the wafer. Methods of this type are also called wafer level processing.

The guide medium can comprise or consist of glass.

The outcoupling mirror can be arranged on the top side of the upper guide medium, and the end mirror can be arranged on the bottom side of the lower guide medium.

The outcoupling mirror can comprise one or more layers. The same applies to the end mirror.

In particular, the outcoupling mirror can comprise or consist of one or more layers on the top side of the upper guide medium or of the laser medium, and the end mirror can comprise or consist of one or more layers on the bottom side of the lower guide medium or of the laser medium.

In accordance with one embodiment, the end mirror is designed as an incoupling mirror and the radiation source and the laser resonator are arranged relative to one another in such a way that the pump radiation is incoupled into the laser resonator via the incoupling mirror.

This can be achieved by the end mirror used being a wavelength-selective mirror which is transmissive for the pump radiation and highly reflective for the laser radiation.

A wavelength-selective mirror can likewise be used as outcoupling mirror. The wavelength of the laser can be stabilized as a result. In particular, a reflectivity of the outcoupling mirror can have a maximum at a principal wavelength of the laser radiation and can decrease toward longer and/or shorter wavelengths, in order to stabilize the wavelength.

In accordance with one embodiment, the solid-state laser comprises a wavelength-selective reflection coating arranged on at least one of the reflectors and suitable for stabilizing a principal wavelength of the laser radiation. In order to achieve this a reflectivity of the at least one reflector, on account of the reflection coating, can have a maximum at the principal wavelength and can decrease toward wavelengths longer and/or shorter than the principal wavelength.

In accordance with one embodiment, the solid-state laser additionally comprises a housing. The latter can be hermetic and can be formed by a carrier, the layer-like laser medium and a frame connecting the carrier to the layer-like laser medium. The frame can comprise one or more side walls. The pump radiation source can be arranged in the housing, in particular on the carrier, e.g. on the top side thereof.

The carrier can be a PCB (printed circuit board), a ceramic carrier, a metal-core circuit board or a QFN substrate. The pump radiation source can be soldered or adhesively bonded on the carrier.

The pump radiation source can comprise a semiconductor laser. In particular, this can involve one or more semiconductor lasers, in particular one or more surface emitting semiconductor lasers, for example a VCSEL array.

In the case of the housing described above, the pump radiation source can comprise or consist of one or more surface emitting semiconductor lasers arranged on the carrier, in particular one or more VCSEL (Vertical Cavity Surface Emitting Laser) or HCSEL (Horizontal Cavity Surface Emitting Laser), for example a VCSEL array.

The laser can be based on the material system GaN.

In accordance with one embodiment, the laser medium comprises or consists of a laser crystal. The latter can be doped with a rare earth metal, in particular Tb3+ or Pr3+.

The laser medium can be a planar laser crystal. The latter can have a thickness of 0.2 to 2 mm inclusive.

The solid-state laser 1 can be used e.g. in a spectrometer or in augmented reality glasses, also called AR glasses, or in virtual reality glasses, also called VR glasses.

### BRIEF DESCRIPTION OF THE DRAWINGS

The invention is explained in greater detail below in association with the figures, which schematically show:

FIG. 1: an optically pumped solid-state laser in accordance with a first exemplary embodiment,

FIG. 2: an optically pumped solid-state laser in accordance with a second exemplary embodiment,

FIG. 3: an optically pumped solid-state laser in accordance with a third exemplary embodiment.

### DETAILED DESCRIPTION

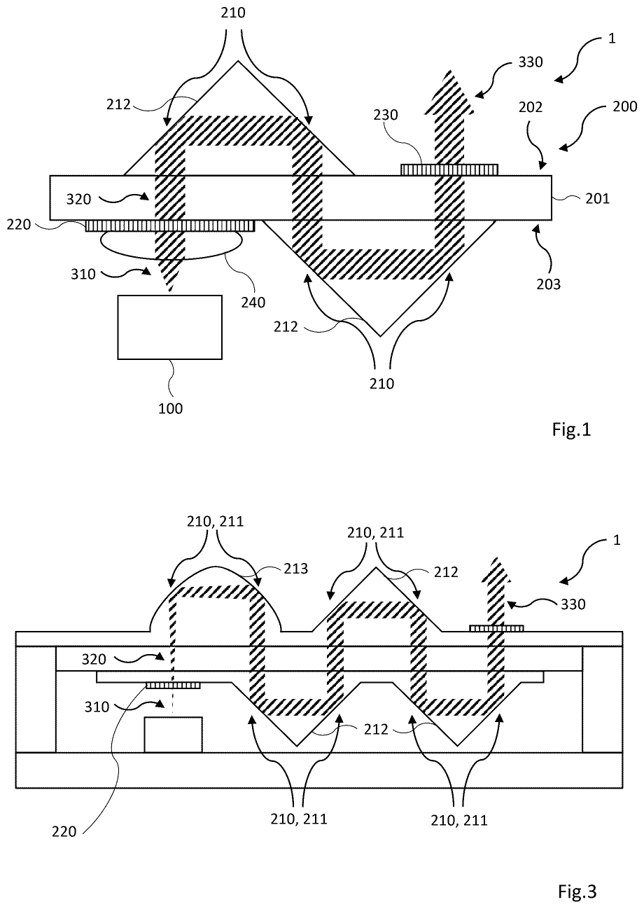

FIG. 1 illustrates an optically pumped solid-state laser 1 in accordance with a first exemplary embodiment. Essential component parts of the solid-state laser 1 are the pump radiation source 100 and also the laser resonator 200. In the present case, the pump radiation source 100 is a GaN-based vertical cavity surface emitting laser (VCSEL). As an alternative thereto, for example, any other semiconductor laser can be used, in particular some other vertically emitting laser, for example a horizontal cavity surface emitting laser (HCSEL), or else an edge emitting semiconductor laser, or else an array of such lasers. The pump radiation source 100 is arranged relative to the laser resonator 200 in such a way that the pump radiation 310 emitted by the pump radiation source 100 is incoupled into the laser resonator 200 via the end mirror 220 and the laser resonator 200 is accordingly pumped by the pump radiation 310 of the pump radiation source 100.

The incoupling mirror 220 is a frequency-selective mirror which has a high transmission in the blue spectral range, such that the pump radiation 310 can incouple into the laser resonator 200. At the same time, the incoupling mirror 220 is highly reflective for the longer-wavelength laser radiation 330 to be generated (or the standing wave 320) and forms an end mirror 220 arranged at an end of the laser resonator 200 and serving for reflecting the standing wave 320 to be formed in the laser resonator 200. At its second end, the laser resonator 200 is delimited by the outcoupling mirror 230, which has a relatively high reflectivity in the spectral range of the laser radiation 330, such that the standing wave 320 can form in the resonator 200 and at the same time the laser radiation 330 can be outcoupled from the laser resonator 200 via the outcoupling mirror 230.

As mentioned above, the incoupling mirror 220 is a frequency-selective mirror. In the present case, the incoupling mirror 220 is a frequency-selective multilayer mirror, the individual layers of which are coated onto the bottom side 203 of the laser medium. The outcoupling mirror is coated onto the top side 202 of the laser medium.

The laser resonator 200 comprises four reflectors 210 at which the direction of propagation of the standing wave 320 changes. Accordingly, the standing wave 320 extends in zigzag fashion multiple times through the laser medium 201, which is configured in layer-like fashion in the present exemplary embodiment. Two of the reflectors 210 in each case are formed by the prisms 212 arranged on the top side 202 and respectively the bottom side 203 of the laser medium 201. The standing wave 320 extends in each case substantially perpendicularly through the layer-like laser medium 201.

The solid-state laser 1 in accordance with the first exemplary embodiment furthermore comprises a collimation lens 240, by means of which the divergent pump radiation 310, before being incoupled into the laser resonator 200 via the incoupling mirror 220, is collimated to form an approximately parallel beam.

In the present exemplary embodiment, the laser medium 201 is a laser crystal doped with a rare earth metal. In particular, Tb3+ or Pr3+ is suitable for this doping. By means of these materials, it is possible to produce a laser crystal 201 which is excitable by means of the blue radiation of the GaN-based pump radiation source and emits in a green spectral range (Tb3+) or respectively orange spectral range (Pr3+). These spectral ranges are not accessible with current semiconductor lasers.

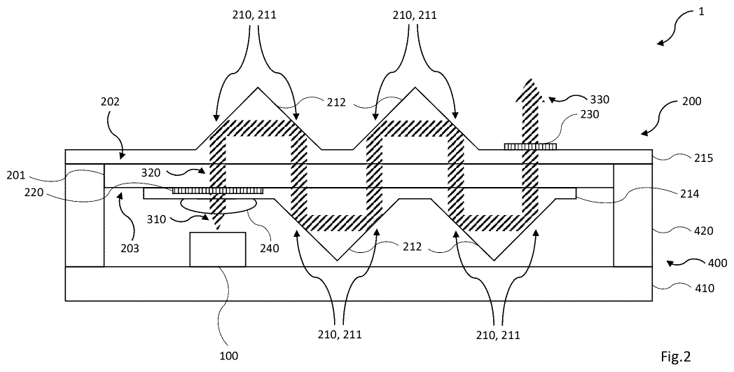

FIG. 2 illustrates an optically pumped solid-state laser 1 in accordance with a second exemplary embodiment. This laser comprises the component parts of the solid-state laser 1 in accordance with the first exemplary embodiment. In addition, the solid-state laser 1 in accordance with the second exemplary embodiment comprises an upper guide medium 215 and a lower guide medium 214, wherein the prisms 212 are formed integrally in these guide media 214, 215. By way of example, the guide media 214, 215 can each be fabricated as an integral glass element together with the prisms 212. In order to fabricate the laser resonator 200, the guide media 214, 215 and the laser medium 201 can then be bonded or adhesively bonded directly onto one another. By way of example, firstly the laser medium 201 can be adhesively bonded onto the upper guide medium 215 and then the lower guide medium 214 can be adhesively bonded onto the resulting semifinished product.

In the present exemplary embodiment, the outcoupling mirror 230 is coated onto the top side of the upper guide medium 215, and the incoupling mirror 220 is coated onto the bottom side 203 of the laser medium 201. As an alternative thereto, the incoupling mirror 220 can also be coated onto the bottom side of the lower guide medium 214 and/or the outcoupling mirror 230 can be coated onto the top side of the laser medium 201.

Furthermore, in the case of the solid-state laser 1 in accordance with the second exemplary embodiment, in contrast to the solid-state laser 1 of the first exemplary embodiment, a preferably hermetic housing 400 is present. The housing comprises a carrier 410, on which the VCSEL 100 is arranged, and also a frame 420 connecting the carrier 410 to the laser resonator 200. Accordingly, carrier 410, frame 420 and laser resonator 200 form a housing 400, in which the VCSEL 100 serving as pump radiation source is arranged.

Furthermore, in the case of the solid-state laser 1 in accordance with the second exemplary embodiment, a wavelength-selective reflection coating 211 is arranged on the reflectors 210, and stabilizes a principal wavelength of the laser radiation 330. The reflection coating is designed in such a way that the reflectivity of the reflectors 210 has a maximum at the principal wavelength (target wavelength) of the laser radiation 330 and decreases toward wavelengths longer and/or shorter than the principal wavelength. A temperature drift of the wavelength of the solid-state laser 1 can be reduced as a result.

Frequency-selective reflection coatings 211 of this type can be attained by applying multilayered mirrors. A further stabilization of the principal wavelength of the laser radiation can be achieved by virtue of the outcoupling mirror 230 also correspondingly being of frequency-selective design, that is to say that its reflectivity has a maximum at the principal wavelength and decreases toward longer and/or shorter wavelengths.

FIG. 3 illustrates an optically pumped solid-state laser 1 in accordance with a third exemplary embodiment. This laser is constructed identically to that in accordance with the second exemplary embodiment, apart from the following differences:

The solid-state laser 1 in accordance with the third exemplary embodiment does not have a collimation lens 240. Instead, the first two reflectors 210 are formed by an elevation having curved edges 213, rather than by a prism 212. Said edges collimate the standing wave, and so the collimation lens 240 is not required. As an alternative thereto, further prisms can also be replaced by suitable elevations 213 having curved edges, thus giving rise overall to collimated laser radiation 330. In the case of the third exemplary embodiment, the incoupling mirror 220 is coated onto the lower guide medium 214.

1. An optically pumped solid-state laser comprising:
a pump radiation source and
a laser resonator for forming at least one standing wave with an active laser medium extending in layer-like fashion,
wherein the pump radiation source and the laser resonator are arranged relative to one another in such a way that the laser resonator can be pumped by the pump radiation source,
wherein the laser resonator is delimited at a first end by an end mirror for reflecting the standing wave, and at a second end by an outcoupling mirror for reflecting the standing wave and outcoupling laser radiation,
wherein the laser resonator has at least four reflectors at which the direction of extent of the standing wave changes,
wherein the end mirror, the outcoupling mirror and the reflectors are arranged relative to the laser medium in such a way that the standing wave extends through the laser medium along its direction of propagation and is then reflected at two successive reflectors at a top side of the laser medium and then once again extends through the laser medium and is then reflected at two successive reflectors at the bottom side of the laser medium and then once again extends through the laser medium.

2. The solid-state laser as claimed in claim 1, wherein the two successive reflectors at the top side of the laser medium are formed by different sections of an upper elevation composed of a guide medium on the laser medium.

3. The solid-state laser as claimed in claim 1, wherein the two successive reflectors at the bottom side of the laser medium are formed by different sections of a lower elevation composed of a guide medium on the laser medium.

4. The solid-state laser as claimed in any claim 2, which is configured in such a way that the standing wave extends substantially perpendicularly through the laser medium.

5. The solid-state laser as claimed in claim 1, wherein the outcoupling mirror and/or the end mirror comprise(s) a layer on the laser medium.

6. The solid-state laser as claimed in claim 1, comprising an upper guide medium arranged on the top side of the laser medium with a plurality of elevations, each forming two of the reflectors and also a lower guide medium arranged on the bottom side of the laser medium with a plurality of elevations, each forming two of the reflectors.

7. The solid-state laser as claimed in claim 6, wherein the outcoupling mirror is arranged on the top side of the upper guide medium and/or the end mirror is arranged on the bottom side of the lower guide medium.

8. The solid-state laser as claimed in claim 1, furthermore comprising a carrier, on which the pump radiation source is arranged, and also a frame connecting the carrier to the layer-like laser medium such that carrier frame, and laser medium form a preferably hermetic housing, in which the pump radiation source is arranged.

9. The solid-state laser as claimed in claim 1, wherein the pump radiation source comprises a semiconductor laser, preferably based on the material system GaN.

10. The solid-state laser as claimed in claim 8, wherein the semiconductor laser is a surface emitting semiconductor laser arranged on the carrier.

11. The solid-state laser as claimed in claim 1, wherein the end mirror is designed as an incoupling mirror and the radiation source and the laser resonator are arranged relative to one another in such a way that the pump radiation is incoupled into the laser resonator via the incoupling mirror.

12. The solid-state laser as claimed in claim 1, wherein the laser medium comprises or consists of a laser crystal doped with a rare earth metal, in particular Tb3+ or Pr3+.

13. The solid-state laser as claimed in 1, comprising a wavelength-selective reflection coating arranged on at least one of the reflectors and suitable for stabilizing a principal wavelength of the laser radiation.

14. The solid-state laser as claimed in claim 13, wherein a reflectivity of the at least one reflector, on account of the reflection coating, has a maximum at the principal wavelength and decreases toward wavelengths longer and/or shorter than the principal wavelength.
